(19) United States
(12) Patent Application Publication
(10) Pub. No.: US 2013/0297287 A1
(43) Pub. Date: Nov. 7, 2013

(54) DISPLAY TWO KEYBOARDS ON ONE TABLET COMPUTER TO ALLOW TWO USERS TO CHAT IN DIFFERENT LANGUAGES

(71) Applicant: Jun Yin, Sunnyvale, CA (US)

(72) Inventor: Jun Yin, Sunnyvale, CA (US)

(73) Assignee: Google Inc., Mountain View, CA (US)

(21) Appl. No.: 13/465,241

(22) Filed: May 7, 2012

(51) Int. Cl. G06F 17/28

(52) U.S. Cl. 704/3; 704/2

(57) ABSTRACT

A system and related techniques for communicating in different languages between two users on a mobile computing device is provided. The system includes a communication module, a user interface module and a display. The communication module receives a first language communication and requests a first translated communication in a second language that corresponds to the first language. The communication module receives a second language communication and requests a second translated communication in the first language that corresponds to the second language. The user interface module generates a first output corresponding to the first translated communication and generates a second output corresponding to the second translated communication. The display includes a first display region that displays the first language communication and a second display region that displays the first output. The first display region and the second display region are offset relative to each other on the display.

### FIELD

The present disclosure relates to mobile computing devices and, more particularly, to a mobile computing device and related techniques incorporating two keyboards on a single display to allow two users to chat in different languages.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The term “mobile computing device” includes various portable computing devices, including but not limited to tablet computers, mobile phones, laptop computers, and personal digital assistants. Mobile computing devices may selectively communicate via one or more networks such as a mobile telephone network, the Internet, and the like. Mobile computing devices typically incorporate a user interface configured to receive an input from a user. Such user interfaces may incorporate a touch display, a touch pad, various buttons, and/or a keyboard or a partial QWERTY-based keyboard to receive input from the user.

### SUMMARY

A computer-implemented method according to the present disclosure includes receiving, at a computing device, a request to enter a translation communication mode including a first language and a second language. A first communication is received at the computing device from a first keyboard in the first language. The first communication is provided to a translation engine. A first translated communication is received at the computing device. The first translated communication is in the second language and corresponds to the first communication. The first translated communication is displayed on a display of the computing device. A second communication is received at the communication device from a second keyboard in the second language. The second communication is provided to the translation engine. The second translated communication is received at the computing device. The second translated communication is in the first language and corresponds to the second communication. The second translated communication is displayed on the display of the communication device. The first and second keyboards and translated communications are displayed concurrently on the display of the computing device. The first keyboard and translated communication are both oriented in a first direction. The second keyboard and translated communication are both oriented in a second direction. The first and second directions are opposite.

According to additional features of the present teachings, the first and second keyboards are arranged on a touch display. The first translated communication is displayed on a first display region of the display. The second translated communication is displayed on a second display region of the display. The first and second display regions are offset. The first display region is oriented in a first direction on the display. The second display region is oriented in a second direction on the display. The first and second directions are different. The first communication is displayed on the display as text. The second communication is displayed on the display as text.

A system for communicating in different languages between two users on a mobile computing device according to the present disclosure includes a communication module, a user interface module and a display. The communication module receives a first language communication and requests a first translated communication in a second language that corresponds to the first language. The communication module receives a second language communication and requests a second translated communication in the first language that corresponds to the second language. The user interface module generates a first output corresponding to the first translated communication and generates a second output corresponding to the second translated communication. The display includes a first display region that displays the first language communication and a second display region that displays the first output. The first display region and the second display region are offset relative to each other on the display.

According to additional features, the display includes a first and a second keyboard arranged on the display. The first display region further displays the second output. The second display region further displays the second language communication. The first and second display regions are oriented in opposite directions. The communication module receives the first language communication as text from the first keyboard arranged on the display. The communication module receives the second language communication as text from the second keyboard arranged on the display.

According to still other features, the communication module receives the first language communication as a first audio input from a microphone on the mobile computing device. The user interface module receives the second language communication as a second audio input from the microphone on the mobile computing device. The mobile computing device comprises a tablet computer having the display incorporated thereon.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a front perspective view of a mobile computing device that incorporates a user interface including a touch display having first and second display regions according to some embodiments of the present disclosure;

FIG. 2 is a functional block diagram of the mobile computing device of FIG. 1;

FIG. 3 is a functional block diagram of the touch display and communication module of the mobile computing device shown in FIG. 2 and that communicates with a translation engine according to some embodiments of the present disclosure; and

FIG. 4 is a flow diagram of an example technique for displaying first and second translated communications on the display of FIG. 1 according to some embodiments of the present disclosure.

### DETAILED DESCRIPTION

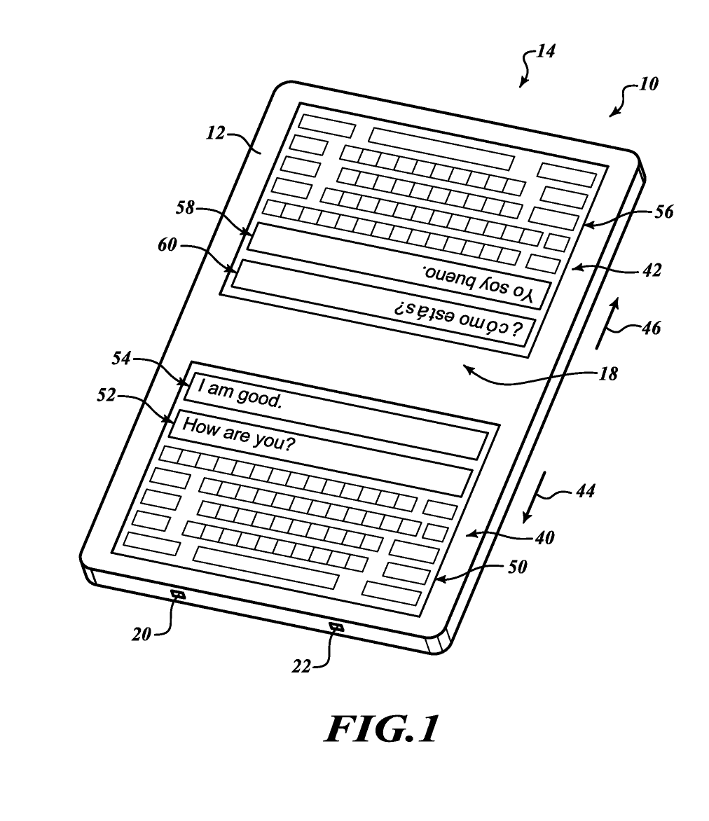

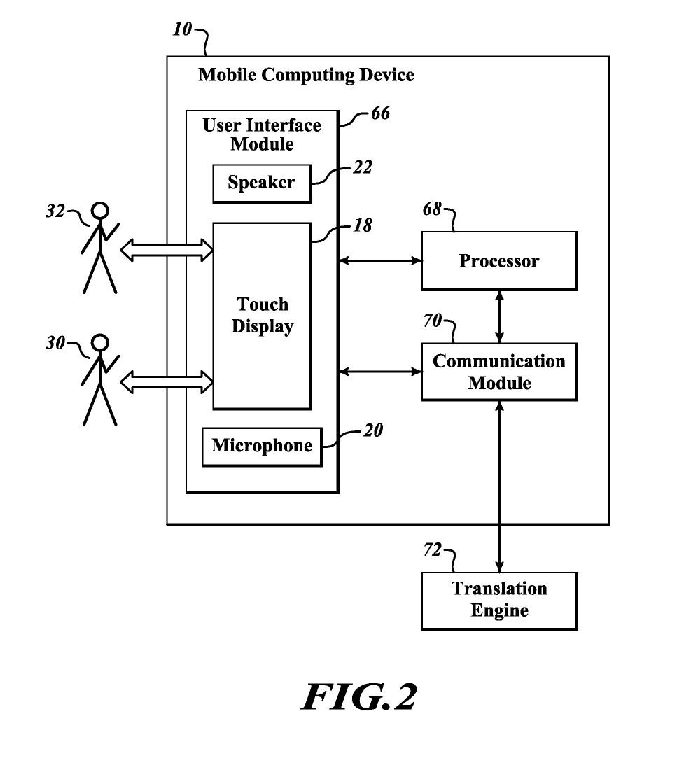

With initial reference to FIGS. 1 and 2, a mobile computing device constructed in accordance with some embodiments of the present teachings is shown and generally identified at reference numeral 10. The mobile computing device 10 includes a housing 12 and a user interface 14. According to one example of the present disclosure, the mobile computing device 10 is in the form of a tablet computer. It will be appreciated however that the mobile computing device 10 may take other forms such as, but not limited to, a mobile phone, a laptop computer or a personal digital assistant. As will be described more fully herein, the mobile computing device 10 allows two users to communicate with each other using two different languages.

The user interface 14 may generally include a viewable screen or touch display 18. The mobile computing device 10 may additionally include a microphone 20 and at least one speaker 22 arranged on the housing 12. The touch display 18 may be a capacitive sensing display or any other touch sensitive display device. The touch display 18 according to the present disclosure may display information to and receive input from a first user 30 and a second user 32. As will become appreciated more fully from the following discussion, both of the first user 30 and the second user 32 may input information to the mobile computing device 10 via the touch display 18, e.g., by touching or providing a touch input using one or more of their fingers.

With particular reference now to FIG. 1, additional features of the touch display 18 of the user interface 14 will be described. The touch display 18 may be configured to include a first display region 40 and a second display region 42. The first display region 40 may be oriented in a first display direction 44 while the second display region 42 may be oriented in a second display direction 46. In the particular example shown, the first display direction 44 is arranged in a first direction for viewing by the first user 30. The second display direction 46 is arranged in an opposite direction for viewing by the second user 32. In this regard, the first and second display regions 40 and 42 may be arranged such that the first and second users 30 and 32 may face each other making it further convenient to communicate body language including facial expressions during the course of a conversation while using the mobile computing device 10.

The first display region 40 may generally include a first keyboard 50, a first display field 52 and a second display field 54. The second display region 42 may generally include a second keyboard 56, a third display field 58, and a fourth display field 60. In the particular embodiment shown, the first keyboard 50 may receive an input from the first user 30 and the second keyboard 56 may receive a second input from the second user 32. Input entered through the first keyboard 50 may be displayed in the first display field 52. Input entered through the second keyboard 56 may be displayed on the third display field 58. As will be referred to herein, the first display field 52 may be configured to display a first source language entered by the first user 30 through the first keyboard 50. Similarly, the third display field 58 can be configured to display a second source language entered by way of the second keyboard 56 by the second user 32.

The second display field 54 may be configured to display a translated second language. The translated second language corresponds to a translation of the second source language (displayed on the third display field 58) into the first language. The fourth display field 60 may be configured to display a translated first language. The translated first language corresponds to a translation of the first source language (displayed on the first display field 52) into the second language. As will become more fully appreciated from the following discussion, the first user 30 may input a first communication in a first source language as displayed in the first display field 52. The mobile computing device 10 is configured to translate the first source language as entered by the first user 30 through the first keyboard 50 and display the translated first source language in the fourth display field 60. Similarly, the mobile computing device 10 may be configured to translate the second source language as entered by the second user 32 through the second keyboard 56 and display the translated second source language in the second display field 54.

For purposes of discussion, and as shown in the example illustrated in FIG. 1, the first user 30 may communicate in English while the second user 32 may communicate in Spanish. The configuration of the touch display 18 of the user interface 14 provided in the mobile computing device 10 according to the present disclosure facilitates translated communication between the first and second users 30 and 32 on a common display 18. It will be appreciated that the mobile computing device 10 may be configured to provide translated communication between two users using any two desired languages. Referring now to FIG. 1, the first user 30 may type through the first keyboard 50 the question “How are you?” that may be displayed on the first display field 52. The mobile computing device 10 is configured to acquire and provide a translation of the first communication and display the first translated communication in the desired language (Spanish). In the example provided, the phrase “ [symbol] Cómo estás?” is displayed on the fourth display field 60. The second user 32 can subsequently or concurrently enter a second communication by way of the second keyboard 56 that is displayed in the third display field 58. In the example shown, the second user 32 enters the phrase “Yo soy bueno”. The mobile computing device 10 may be configured to acquire and provide a translation of the second source language back to the first language and display the translated second language in the second display field 54. In the example shown, the second display field 54 displays “I am good.”.

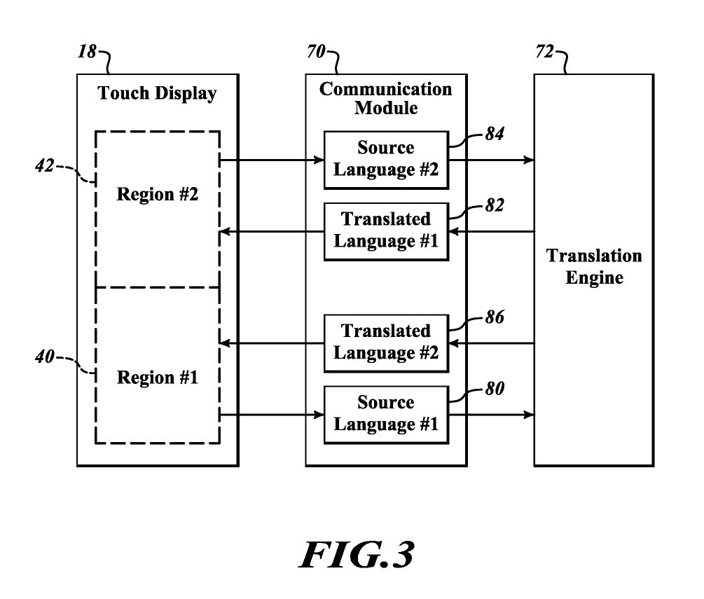

Referring now to FIGS. 2 and 3, a functional block diagram of an example mobile computing device 10 according to various embodiments of the present disclosure is shown. The mobile computing device 10 may include the touch display 18, the microphone 20, the speaker 22, a user interface module 66, a processor 68, and a communication module 70. The communication module 70 may be in communication with a translation engine 72.

The first and second users 30 and 32 may communicate with the mobile computing device 10 concurrently via the user interface 14 including the touch display 18. In particular, the touch display 18 may display information to and receive input from the first and second users 30 and 32. The user interface module 66, alone or in combination with the processor 68 can control the touch display 18. Specifically, the processor 68 may generate or manipulate the information to be displayed in the first, second, third, and fourth display fields 52, 54, 58, and 60, respectively to the first and second users 30 and 32 via the touch display 18. The user interface module 66 and the processor 68 may also interpret the input received from the first and second users 30 and 32, respectively, via the touch display 18. The communication module 70 can be configured to receive a first language communication or first source language 80 and request a first translated communication in a second language to the translation engine 72. The communication module 70 can receive a translated first language 82 from the translation engine 72. The communication module 70 can communicate the translated first language 82 to the touch display 18 for display on the fourth display field 60 (FIG. 1) of the second display region 42. Similarly, the communication module 70 can receive a second language communication or second source language 84 from the second display region 42 of the touch display 18 and request a second translated communication in the first language from the translation engine 72. The translation engine 72 can provide a translated second language 86 to the communication module 70. The communication module 70 can communicate the second translated language 86 to the second display field 54 (FIG. 1) of the first display region 40 of the touch display 18.

The processor 68 may control most operations of the mobile computing device 10. The processor 68, therefore, may communicate with both of the user interface module 66 and the communication module 70. For example, the processor 68 may perform tasks such as, but not limited to, loading/controlling an operating system of the mobile computing device 10, loading/configuring communication parameters for the communication module 70 and controlling various parameters of the user interface 14 and its components. The processor 68 may also perform the loading/controlling of software applications, and the controlling of memory storage/retrieval operations, e.g., for loading of the various parameters.

The communication module 70 controls communication between the mobile computing device 10 and other devices. For example only, the communication module 70 may provide for wireless communication between the mobile computing device 10 and other users via a cellular telephone network, and/or between the mobile computing device 10 and a wireless network. Examples of wireless networks include, but are not limited to, the Internet, a wide area network, a local area network, a satellite network, a telecommunications network, a private network, and combinations of these. The communication module 70 according to the present disclosure can communicate with the translation engine 72. The translation engine 72 can be any suitable engine operable to perform translation. The translation engine 72 may be implemented on a remote server (not shown). According to other examples, translation may be carried out in the mobile computing device 10 such as by the processor 68 or a combination of the processor 68 and a remote server. The translation engine 72 receives the first source language 80 to be translated and a target language thereof. The translation engine 72 translates the first source language and communicates a translated first language 82 back to the communication module 70. Similarly, the translation engine 72 may receive a second source language 84 and a target language thereof. The translation engine 72 may communicate the translated second source language 86 back to the communication module 70.

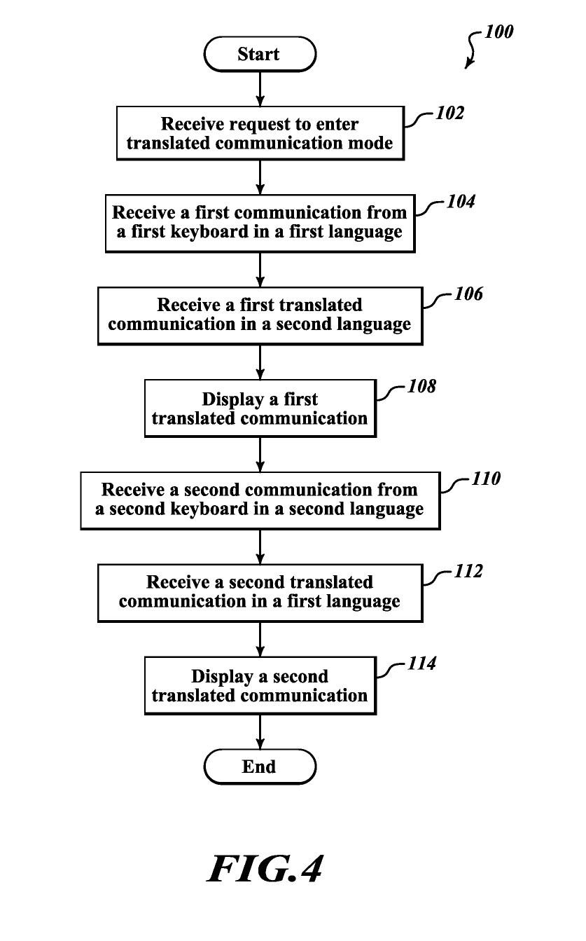

Referring now to FIG. 4, an example of a technique 100 for using the mobile computing device 10 according to some embodiments of the present disclosure is illustrated. At 102, the communication module 70 receives a request to enter a translated communication mode. The request may include a selection of the first and second languages. At 104, the communication module 70 receives a first communication 80 from the first keyboard 50 in the first source language. At 106, the communication module 70 receives a first translated communication 82 in the second language. At 108, the first translated communication is displayed on the fourth display field 60 of the second display region 42. At 110, the communication module 70 receives a second communication 84 from the second keyboard 56. At 112, the communication module 70 receives a second translated communication 86 in the first language. At 114, the second translated communication 86 is displayed in the second display field 54 of the first display region 40.

According to another embodiment, translated communication may be initiated as speech. In this regard, the communication module 70 may receive audio inputs from one of or both of the first user 30 and the second user 32. The audio inputs may be captured by the microphone 20 and provided through the user interface module 66 to the communication module 70 and/or the processor 68. An audio input can be converted to text by the processor 68, alone or in combination with a remote server (not shown), by a standard speech recognition (speech-to-text) algorithm. The mobile computing device 10 can be in communication with the remote server through a network, e.g., the Internet. The remote server may execute the translation engine 72, may provide speech-to-text functionality and/or any other service. In this regard, the remote server may implement speech-to-text conversion for any or all of the first and second communications 80, 84 and first and second translated communications 82, 86. It should be appreciated that the mobile device 10, alone or in combination with the remote server, may further implement a text-to-speech algorithm such that the first and second users 30, 32 can receive audio output instead of, or in addition to, the translated communications being displayed.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method comprising:
receiving, at a computing device, a request to enter a translation communication mode including a first language and a second language;
receiving, at the computing device, a first communication from a first keyboard in the first language;
providing the first communication to a translation engine;
receiving, at the computing device, a first translated communication, the first translated communication being in the second language and corresponding to the first communication;
displaying, on a display of the computing device, the first translated communication;
receiving, at the communication device, a second communication from a second keyboard in the second language;
providing the second communication to the translation engine;
receiving, at the computing device, a second translated communication, the second translated communication being in the first language and corresponding to the second communication; and
displaying, on the display of the communication device, the second translated communication;
wherein the first and second keyboards and translated communications are displayed concurrently on the display of the computing device, wherein the first keyboard and the second translated communication are both oriented in a first direction, the second keyboard and the first translated communication are both oriented in a second direction, and wherein the first and second directions are opposite.

2. A computer-implemented method comprising:
receiving, at a computing device, a request to enter a translation communication mode including a first language and a second language;
receiving, at the computing device, a first communication in the first language;
providing the first communication to a translation engine;
receiving, at the computing device, a first translated communication, the first translated communication being in the second language and corresponding to the first communication;
displaying, on a display of the computing device, the first translated communication;
receiving, at the communication device, a second communication in the second language;
providing the second communication to the translation engine;
receiving, at the computing device, a second translated communication, the second translated communication being in the first language and corresponding to the second communication; and
displaying, on the display of the communication device, the second translated communication;
wherein the first and second translated communications are displayed concurrently on the display of the computing device.

3. The computer-implemented method of claim 2, wherein receiving the first communication comprises receiving the first communication from a first keyboard.

4. The computer-implemented method of claim 3, wherein receiving the second communication comprises receiving the second communication from a second keyboard.

5. The computer-implemented method of claim 4, wherein the first and second keyboards are displayed concurrently on the display of the computing device.

6. The computer-implemented method of claim 5, wherein receiving the first and second communications from the first and second respective keyboards comprises receiving the first and second communications from the first and second keyboards arranged on a touch display.

7. The computer-implemented method of claim 5, wherein the first keyboard and the second translated communication are both oriented in a first direction on the display of the computing device and wherein the second keyboard and the first translated communication are both oriented in a second direction on the display of the computing device, wherein the first and second directions are opposite.

8. The computer-implemented method of claim 7,
wherein displaying the second translated communication comprises displaying the second translated communication on a first display region; and
wherein displaying the first translated communication comprises displaying the first translated communication on a second display region, the second display region being offset relative to the first display region.

9. The computer-implemented method of claim 8, wherein displaying the first translated communication comprises orienting the first display region in a first direction on the display and orienting the second display region in a second direction on the display, wherein the first and second directions are different.

10. The computer-implemented method of claim 2, further comprising:
displaying the first communication on the display, wherein the first communication comprises text.

11. The computer-implemented method of claim 10, further comprising:
displaying the second communication on the display, wherein the second communication comprises text.

12. A system for communicating in different languages between two users on a mobile computing device, the system comprising:
a communication module that (i) receives a first language communication and requests a first translated communication in a second language that corresponds to the first language communication and (ii) receives a second language communication and requests a second translated communication in the first language that corresponds to the second language communication;
a user interface module that (i) generates a first output corresponding to the first translated communication and (ii) generates a second output corresponding to the second translated communication; and
a display including a first display region that displays the first language communication and a second display region that displays the first output, wherein the first display region and the second display region are offset relative to each other on the display.

13. The system of claim 12 wherein the display includes a first and a second keyboard arranged on the display.

14. The system of claim 13 wherein the first display region further displays the second output and wherein the second display region further displays the second language communication.

15. The system of claim 14 wherein the first and second display regions are oriented in opposite directions.

16. The system of claim 12 wherein the communication module receives the first language communication as text from the first keyboard arranged on the display.

17. The system of claim 16 wherein the communication module receives the second language communication as text from the second keyboard arranged on the display.

18. The system of claim 12 wherein the communication module receives the first language communication as a first audio input from a microphone on the mobile computing device.

19. The system of claim 18 wherein the user interface module receives the second language communication as a second audio input from the microphone on the mobile computing device.

20. The system of claim 12 wherein the mobile computing device comprises a tablet computer having the display incorporated thereon.
